(19) United States
(12) Patent Application Publication
(10) Pub. No.: US 2012/0315795 A1
(43) Pub. Date: Dec. 13, 2012

(54) SERIAL ADVANCED TECHNOLOGY ATTACHMENT AND SERIAL ADVANCED TECHNOLOGY ATTACHMENT ASSEMBLY WITH THE SAME

(75) Inventors: LI-REN FU, Shenzhen City (CN); HAN-BING ZHANG, Shenzhen City (CN); JUN-HUI WANG, Shenzhen City (CN); AI-LING HE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/274,594

(22) Filed: Oct. 17, 2011

(30) Foreign Application Priority Data
Jun. 10, 2011 (CN) 201120194770.6

(51) Int. Cl. H01R 13/40; H01R 13/62

(52) U.S. Cl. 439/625; 439/345

(57) ABSTRACT

A SATA assembly includes a MSD and a SATA. The MSD includes a SATA interface, the SATA interface defines a slot. The SATA includes an insulative body, and a resilient plate. The resilient plate is fixed to the insulative body, the resilient plate includes a main section, a resilient arm protruding from the main section, and a latching portion protruding from the resilient arm. The latching portion is latched in the slot to hold the SATA in the SATA interface.

### BACKGROUND

1. Technical Field

This disclosure relates to serial advanced technology attachments, and in particular, to a serial advanced technology attachments for a mass storage device.

2. Description of Related Art

Serial advanced technology attachment (SATA) includes a connector for connecting host bus adapters to mass storage devices. However, the connector is typically connected to the mass storage devices only by the friction force between the connector and the mass storage devices. Thus, the connector may easily separate from the mass storage devices during transport of the mass storage devices.

Therefore, there is a room for improved in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary serial advanced technology attachment assembly. Moreover, in the drawings like reference numerals designate corresponding parts throughout the several views. Wherever possible, the same reference numbers are used throughout the drawings to refer to the same or like elements of an embodiment.

FIG. 1 is an exploded view of an exemplary serial advanced technology attachment assembly including a serial advanced technology attachment and a mass storage device.

FIG. 2 is an enlarged view of the serial advanced technology attachment of FIG. 1.

FIG. 3 is a schematic view of the mass storage device of FIG. 1 viewing from another aspect.

FIG. 4 is an assembled view of the serial advanced technology attachment assembly of FIG. 1.

FIG. 5 is a cross sectional view of the serial advanced technology attachment assembly of FIG. 4.

### DETAILED DESCRIPTION

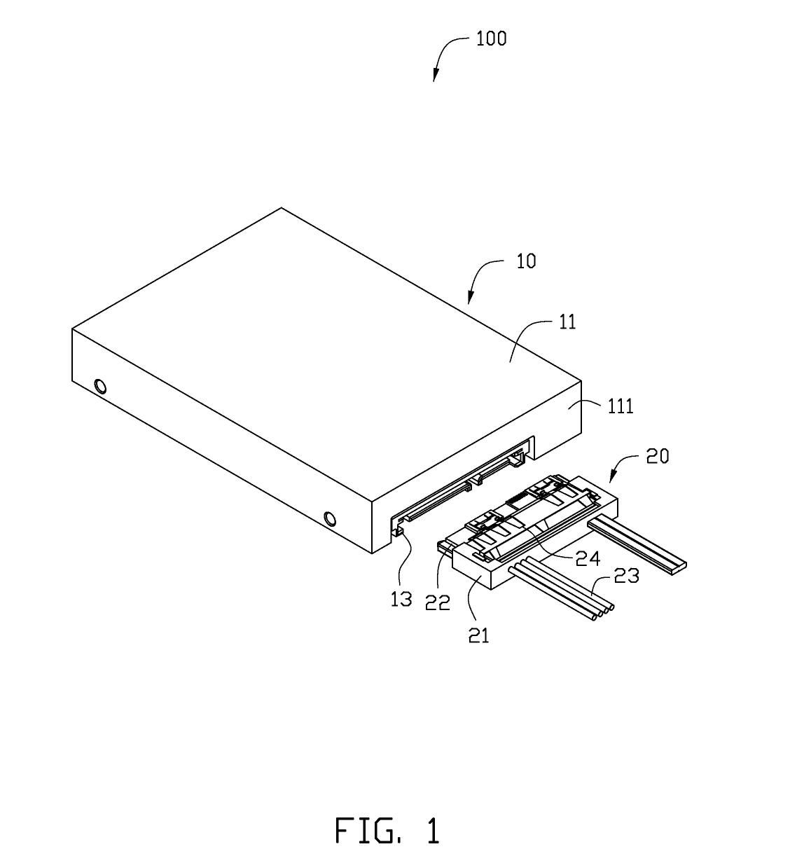

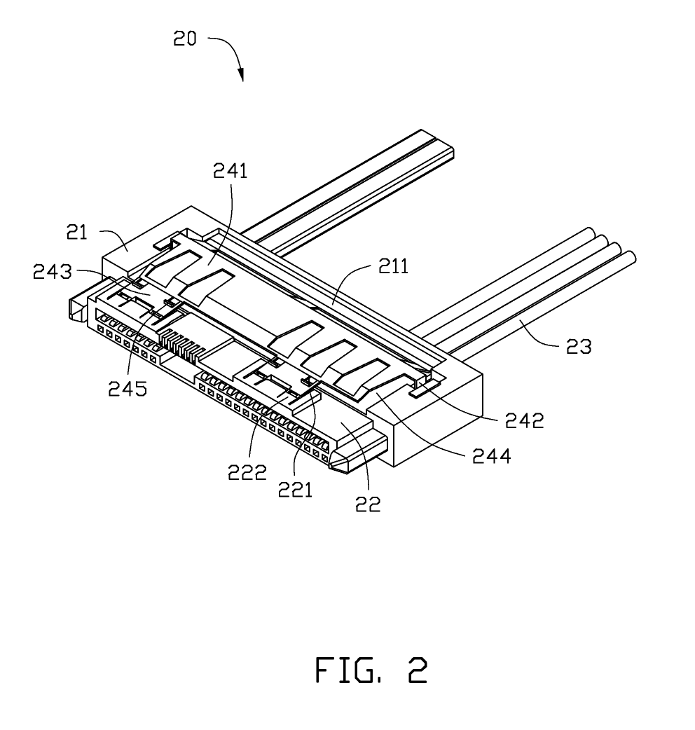

Referring to FIGS. 1 and 2, an exemplary embodiment of serial advanced technology attachment assembly 100 includes a mass storage device (MSD) 10 and a serial advanced technology attachment (SATA) 20 for connecting the MSD 10 to a host bus adapter (not shown). The MSD 10 includes a main body 11 and a SATA interface 13 defined in the main body 11.

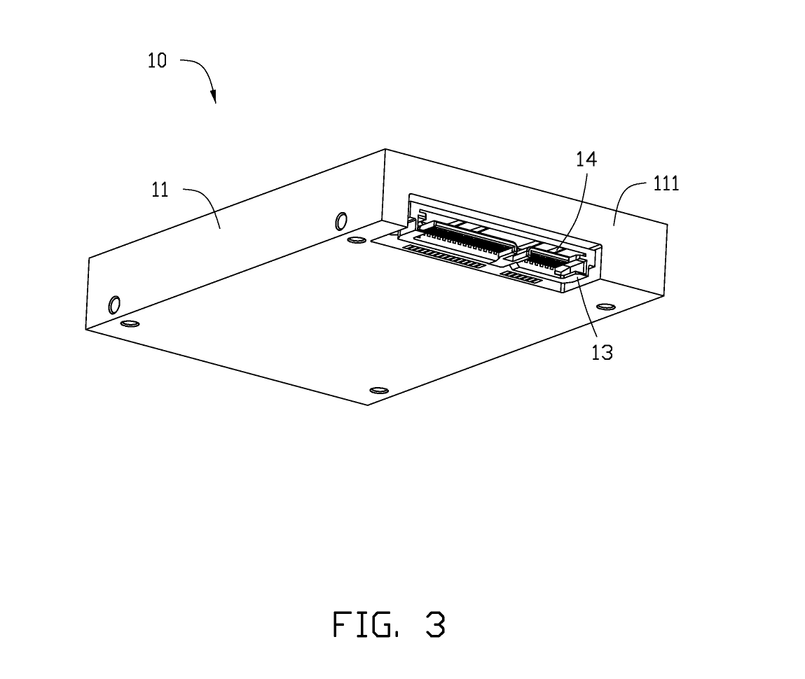

Referring to FIGS. 2 and 3, the main body 11 includes a sidewall 111, in which the SATA interface 13 is defined. The SATA interface 13 defines a plurality of latching slots 14 for latching the SATA 20 in the SATA interface 13.

The SATA 20 includes an insulative body 21, an inserting section 22 protruding from one end of the insulative body 21 and a cable 23 protruding from another end of the insulative body 21. The inserting section 22 is inserted in the SATA interface 13 so the SATA 20 is electrically connected to the MSD 10. The cable 23 is used to connect the MSD 10 to the host bus adapter.

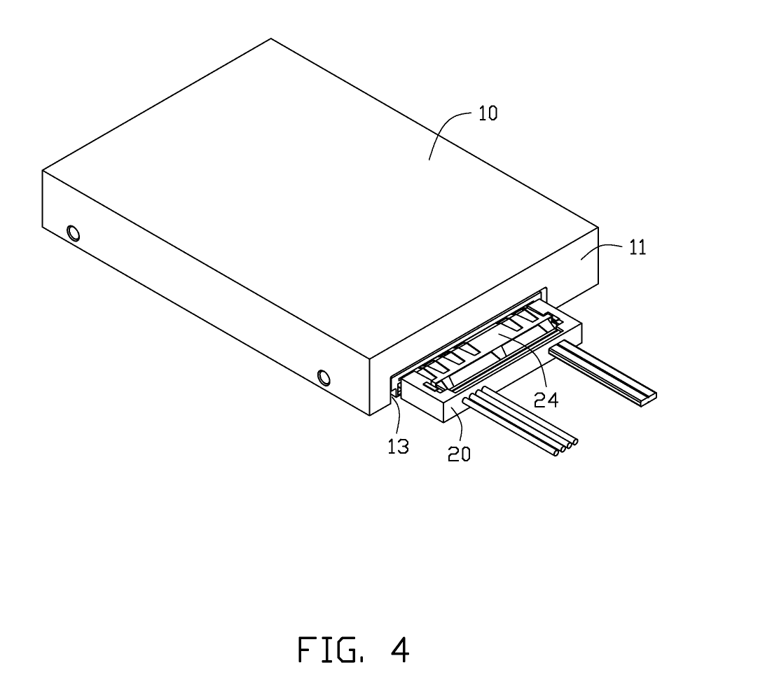

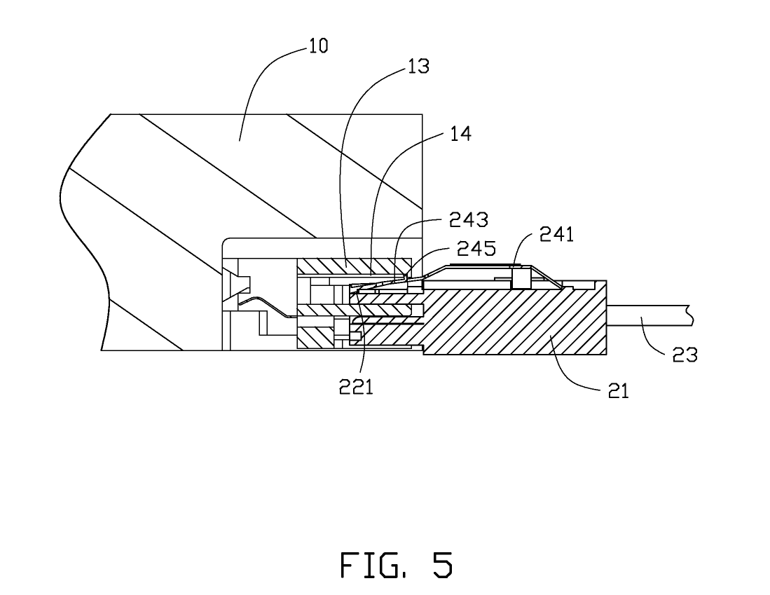

Referring to FIGS. 4 and 5, the SATA 20 further includes a resilient plate 24 fixed to the insulative body 21. The resilient plate 24 is for releasably latching the SATA 20 to the SATA interface 13. In this exemplary embodiment, the resilient plate 24 includes a main section 241, two retaining portions 243 respectively bent from two sides of the main section 241. The retaining portions 243 are retained (e.g., hot-melted) to the insulative body 21 to hold the resilient plate 24 to the insulative body 21. When the retaining portions 243 are retained to the insulative body 21, the main section 241 is located at a first position above the insulative body 21, i.e., the main section 241 is spaced from the insulative body 21, thereby a gap 244 is defined between the main section 241 and the insulative body 21, facilitating the main section 241 moving toward a second position adjacent the insulative body 21 when the main section 241 is pressed. The resilient plate 24 further includes two resilient arms 243 protruding from the main section 241, and a plurality of latching portions 245 protruding from the resilient arms 243. Each latching portion 245 is latched in one of the slots 14 to firmly hold the SATA 20 to the SATA interface 13.

The insulative body 21 further defines two retaining grooves 221, in which a distal end of each resilient arm 243 is retained, to prevent the distal ends of the resilient arms 243 from spacing from the insulative body 21, to facilitate the latching portions 245 entering into the slots 14.

It is to be further understood that even though numerous characteristics and advantages of the exemplary embodiments have been set forth in the foregoing description, together with details of structures and functions of various embodiments, the disclosure is illustrative only, and changes may be made in detail, especially in matters of shape, size, and arrangement of parts within the principles of the exemplary invention to the full extent indicated by the broad general meaning of the terms in which the appended claims are expressed.

What is claimed is:

1. A SATA comprising:
an insulative body; and
a resilient plate formed on the insulative body, the resilient plate including a main section, a resilient arm protruding from the main section, and a plurality of latching portions protruding from the resilient arm;
wherein the main section has a first position spaced from the insulative body.

2. The SATA of claim 1, wherein the resilient plate further comprises two retaining portions respectively bent from two sides of the main section, the retaining portions are retained to the insulative body to hold the resilient plate to the insulative body.

3. The SATA of claim 1, wherein a gap is defined between the main section and the insulative body, facilitating the main section moving toward a second position adjacent the insulative body when the main section is pressed.

4. The SATA of claim 1, wherein the insulative body further defines a retaining grooves, in which a distal end of the resilient arm is retained, to prevent the distal end of the resilient arm from spacing from the insulative body.

5. A SATA assembly comprising:
a MSD including a SATA interface, the SATA interface defining a slot; and
a SATA, comprising:
an insulative body; and
a resilient plate formed on the insulative body, the resilient plate including a main section, a resilient arm protruding from the main section, and a latching portion protruding from the resilient arm; <work in first position>
wherein the latching portion is latched in the slot to hold the SATA in the SATA interface.

6. The SATA assembly of claim 5, wherein the resilient plate further comprises two retaining portions respectively bent from two sides of the main section, the retaining portions are retained to the insulative body to hold the resilient plate to the insulative body.

7. The SATA assembly of claim 5, wherein a gap is defined between the main section and the insulative body, facilitating the main section moving toward a second position adjacent the insulative body when the main section is pressed.

8. The SATA of claim 5, wherein the insulative body further defines a retaining grooves, in which a distal end of the resilient arm is retained, to prevent the distal end of the resilient arm from spacing from the insulative body.
